(19) United States
(12) Patent Application Publication
(10) Pub. No.: US 2010/0217715 A1
(43) Pub. Date: Aug. 26, 2010

(54) CLOSED WASTE MANAGEMENT SYSTEM AND METHOD

(76) Inventor: Aaron David LIPCON, Kennesaw, GA (US)

Correspondence Address: NANCY J. FLINT, 1844 N. NOB HILL ROAD, #424, PLANTATION, FL, 33322, US

(21) Appl. No.: 12/393,180

(22) Filed: Feb. 26, 2009

(51) Int. Cl. G06Q 10/00

(52) U.S. Cl. 705/308; 705/7

(57) ABSTRACT

A closed waste management system and method is disclosed. The system and method of the invention allows a waste generator and a system operator to maximize value for the processing of collected waste according to variable costs and benefits that may depend on location and intangible benefits to the waste generator. The system and method of the invention allows for accurate accounting of costs and value within the organization of the waste generator and also allows for accurate record-keeping for compliance issues relating to waste disposal.

### BACKGROUND OF THE INVENTION

There is a great emphasis today on “environmentally friendly” and “green” products and programs. One aspect of this is waste management, including recycling. Recycling is defined by the United States Environmental Protection Agency (“EPA”) as “a series of activities that includes collecting recyclable materials that would otherwise be considered waste, sorting and processing recyclables into raw materials such as fibers, and manufacturing raw materials into new products.” <http://www.epa.gov/epaoswer/non-hw/muncpl/recycle.htm>, Jul. 16, 2008. Consumers and businesses alike are taking steps to recycle for many reasons. Recycling may be cost effective or it may be required to comply with local, state and/or federal regulations and laws. Some consumers prefer to conduct business with companies that are environmentally conscious.

Many different types of materials can be recycled, including glass, metals, paper, plastics, oil, batteries and live waste. The facts about recycling are astounding. For example, “[r]ecycling a glass bottle saves enough energy to light a 100-watt bulb for four hours.” RAYS—Recycle and You Save, San Diego County Office of Education 1991. The amount of aluminum Americans throw away annually could rebuild the nation's commercial airliners every three (3) months, according to the Clean Air Council. <www.cleanair.org/Waste/wasteFacts.html>, Jul. 16, 2008. Every year enough energy is saved by recycling steel to supply Los Angeles with nearly a decade's worth of electricity. EarthWorks Group, The Recycler's Handbook, The EarthWorks Press, Berkeley, Calif., 1990. Americans discard enough office paper every year to build a twelve (12) foot-high wall of paper from New York to California. Id. Yet, paper does not degrade quickly in landfills, and some are still readable more than 20 years after being thrown away, according to the Dow Chemical Company. Landfills, Dow Chemical Company, 1991. All the polystyrene foam cups made in just one day would circle the earth. Id. In 1987, just to make plastic, the U.S. used enough oil to meet the nation's oil demand for imported oil for five months. RAYS—Recycle and You Save, San Diego County Office of Education, 1991. One gallon of used motor oil can produce the same amount of motor oil as forty-two (42) gallons of crude oil using only about a third of the energy. How to Get More Life Out of Dead Batteries (And Used Motor Oil), Connecticut Department of Environmental Protection. Compost has been shown to improve yields of corn plots when used along with fertilizer, as compared to the use of commercial fertilizer only. Solid Waste Issues and Answers, R.W. Beck and Associates, 1998. In 1992, Americans threw away enough garbage per day to fill an adequate number of garbage trucks to stretch from the earth halfway to the moon. Waste Reduction Guide, Indiana Department of Education, 1992.

The EPA provides an annual report regarding the national municipal solid waste stream. For example, in 2006, recycling rates for consumer goods in the United States were the following:

Newspapers: 87.9%

Corrugated Cardboard Boxes: 72.0%

Steel Cans: 62.9%

Yard Trimmings: 62.0%

Aluminum Beer and Soft Drink Cans: 45.1%

Magazines: 40.5%

Tires: 34.9%

Plastic HDPE Milk and Water Bottles: 31.0%

Plastic Soft Drink Bottles: 30.9%

Glass Containers: 25.3%

Recycling involves the collection and processing of materials, manufacturing products that contain recycled-content and then selling the products containing recycled content to consumers. Recycling collection can involve curbside recycling, drop-off centers, buy-back centers and deposit/refund programs. Collected recyclable materials are sent to a materials recovery facility where they are sorted and prepared into marketable commodities for sale. The recyclable materials are then used in the manufacture of products, where they constitute all or part of the new product's content.

Advantages of recycling include reduction of the amount of energy used by industry, along with the attendant reduction of greenhouse gas emissions from industrial processes and transportation of fossil fuels. Recycling does incur costs, however, such as collection and processing costs. Costs vary from area to area and are dependent on such factors as disposal fees for landfills, waste transfer stations, and incinerators. These can be significant expenses. For example, 1994 landfill disposal fees in the United States ranged from about ten dollars ($10.00) per ton to one hundred and forty dollars ($140.00) per ton. Costs also depend on local resources and demand for recovered materials. Costs are reduced by the amount that the recyclables can be sold to the materials recovery facility, which typically pays for materials on a per-pound basis. In that regard, recyclable materials that have a higher density (weight per volume) often enjoy lower recycling costs because greater weights can be contained in less volume than lower density materials. For example, a truck with a fixed bed volume can carry more weight in steel than in plastic, and therefore be paid more for a load based on weight. This will, of course, depend further on the difference paid per unit of weight for the different types of recyclable materials. The goal is to reach the point where per-ton recycling costs are lower than per-ton garbage collection and disposal costs. The costs of recycling programs generally do not reflect economic benefits that may be realized elsewhere throughout the recycling system, for example the value of saved manufacturing energy saved by recycling the mix of materials collected in a typical curbside collection program.

Recycling is not limited to consumers and consumer products. Many companies today likewise realize not only the social benefits but also the economic benefits of recycling. The types of recyclable materials for companies differ according to the business of these companies. For example, a company that offers car maintenance services may collect and recycle used engine oil. A company that sells office supplies may recycle office supply components, such as printer cartridges and toner. Grocery stores may recycle live goods as well as packaging and transportation materials, such as pallets. Manufacturing facilities may recycle a wide variety of materials, such as drums and waste water.

A benefit to each of these companies may be realized by categorizing its recyclables, which relates to the type(s) of processing available for each recyclable—i.e., recovery, combustion with energy recovery, or landfill or incineration with no energy recovery. Several U.S. patents have issued with respect to recycling systems.

U.S. Pat. No. 6,842,596 to Morii, et. al. (“Morii I”), the contents of which are herein incorporated by reference, discloses a recycling process. A recycling item is sorted into a decomposing group that corresponds to conditions for decomposing the recycling item. The recycled parts obtained by decomposing the recycling item are sorted into at least one of a plurality of material groups according to material of each of the recycling parts. The recycling parts are also sorted into at least one of a plurality of processing groups according to the types of recycling processing to be carried out for each recycling part. The three conditions are transmitted to a recycling processing process where processing is carried out, and the recycling item and recycling parts are sorted.

U.S. Pat. No. 6,766,751 to Liu (“Liu”), the contents of which are herein incorporated by reference, discloses a waste processing method. Waste containers are selected to collect a specified type of waste. The waste containers are given a unique identity, such as a bar code or electronic identification. The content, location, treatment status and end products of the waste in each of the waste containers can be tracked throughout the process according to the unique identifier. The specified waste is collected in the waste containers, the waste containers are transported to a waste processing site, the waste is processed and optionally converted to end products and information about the waste is collected and tracked. The waste processor and the waste generator can analyze the information about the processed waste to alter their operations.

U.S. Pat. No. 5,424,944 to Kelly et. al. (“Kelly”), the contents of which are herein incorporated by reference, discloses a controlled capital asset disposition process. An asset of a customer which is to be disposed of is transported to a disposition facility, sorted in accordance with a preselected method of disposition and disposed of in accordance with the preselected method of disposition according to the customer's instructions. The method of disposition can be a combination of certain options, including selling the asset as-is, refurbishing the asset, dismantling the asset, dysfunctioning the asset, reclaiming the asset, destroying the asset or storing the asset. The disposition can be recorded and certified or verified.

U.S. Pat. No. 6,679,442 to Morii et. al. (“Morii II”), the contents of which are herein incorporated by reference, discloses a plastic closed-loop material recycling process for office automation machines. Used products or machines are collected, classified in accordance with recycling process levels, decomposed and fractionated and acted on physically to produce recycled components. Each step is completely independent, and only information necessary for a step is handled for that step, while a recycle unit definition step balances all of the steps for quality assurance purposes.

### SUMMARY OF THE INVENTION

The invention relates to a reverse logistics waste management system and method for collecting products and materials, recycling and/or disposing of those materials, including collection and separation of materials from one or more waste generators; transportation of the collected and separated materials to warehousing site(s); optional aggregation of similar types of collected and separated materials from a plurality of sources; determination of treatment options for collected and separated materials; transportation of the collected and separated materials to appropriate processor(s), where desired; processing and/or disposal of the materials either as recyclables and/or waste; and reporting of the final processing and/or disposition of the materials to the waste generator. The processing and/or disposition of the materials can be determined according to certain parameters to efficiently accomplish the goals of the waste generator. Such goals may include environmental benefit; revenue maximization for the waste generator; or any other benefit that may be a factor to the waste generator. Further, decisions on processing and/or disposition may depend on a combination of these or any other factors. By “recyclables” it is meant material that can be reprocessed instead of being disposed of as waste.

The system and method of the invention allow a waste generator the opportunity to achieve one or more goals, including goodwill and revenue optimization, through its waste management process. The system and method can take into account dynamic parameters in the market place and aspects that are unique to the physical location of the waste generator. Further, the information tracking features of the invention allow for full accounting by units within the organization of the waste generator for reporting and budgeting purposes. The system and method can also assist the waste generator in tracking and reporting compliance with local, state and federal regulations and statutes regarding waste management, including disposal.

One embodiment of the invention relates to a waste management system comprising a transmitter to transmit a communication from a waste generator that collected waste is ready to be picked up by the system operator; a transportable unit to transport collection units that contain the collected waste of the waste generator; a first interface unit configured to record information about generated waste that is picked up from the waste generator and verification of pick-up; a warehousing center where collected waste is brought by transportable units; a second interface unit configured to record information at the warehousing center about collection units and other generated waste unloaded from the transportable unit; a repair unit to repair certain types of generated waste, such as pallets; a sorting unit to sort certain types of generated waste with regard to type of generated waste and potential reuse, such as pallets; a staging area for aggregating and storing generated waste for shipment to further processing or reuse; and a programmable computer system for communicating with first and second interface units, storing information regarding collected waste received at the warehousing center and disposition of the generated waste to processors and providing access to information about the collected waste, including its disposition, to the waste generator. Optionally, marker/label printers can be located at either or both of the waste generator and the system operator. Further, optionally, additional interface units may be located at other points in the recycling system that can allow for inventory location and reconciliation.

Another embodiment of the invention relates to a method for operating a closed waste management system comprising receiving a communication from a waste generator that collected waste is ready to be picked up; entering information about the collected waste to be picked up into a memory unit and verifying that information by a representative of the waste generator; transporting the collected waste to a warehousing center; unloading and taking an inventory of the unloaded waste at the warehousing center; optionally comparing the inventory taken at the site of the waste generator to the inventory taken when unloading the waste; entering information about the collected waste into a programmable computer system for storage where it can be accessed for review and analysis by system operator and the waste generator; optionally determining the disposal method for waste based on the type of waste in the warehousing center at a particular time; aggregating the unloaded waste with other waste of similar description at the warehousing center; repairing certain types of waste, such as pallets, where desired; sending collected waste for processing to various processors; and storing information about the ultimate disposition of the collected waste in the programmable computer system where it can be accessed and reviewed by system operator and the waste generator. Optionally, generated waste can be sorted after it is received at the warehousing center.

Another embodiment of the invention relates to a method for designing a waste management plan comprising collecting information about processing of various types of waste, which information may be specific to the particular type of waste involved, or may include (if applicable) information about costs of landfill dumping or payments made by recycling processors for that particular type of waste; collecting information about the costs of collecting and transporting waste to the ultimate processor from the waste generator, including storage costs, manpower costs to segregate and load waste into appropriate collection units, transportation costs of transporting waste to a warehousing center and/or to a processor; calculating the cost of disposing a particular load of waste; assigning benefits to particular types of processing choices; and determining and optimizing a value/cost for treating the collected waste.

Other features and advantages of the invention will become apparent from the description of the preferred embodiments in conjunction with the following figures.

### BRIEF DESCRIPTION OF THE DRAWINGS

The invention will be described with reference to the accompanying drawings, in which like elements are referenced with like numerals.

FIG. 1 depicts a waste management system for collecting, transporting, determining treatment plan, processing and/or disposing and reporting of processing of waste materials according to the invention.

FIG. 2 depicts one embodiment of an interface unit for recording information regarding transportable means and collection units picked up at a waste generator facility, along with verification by a representative of the waste generator.

FIG. 3 depicts one embodiment of an interface unit for recording information regarding collection units delivered to a warehousing center

FIG. 4 depicts a method for collecting, transporting, determining treatment plan, processing and/or disposing and reporting of processing of waste materials according to the invention.

FIG. 5 depicts a method for designing a treatment plan to achieve one or more goals with regard to waste disposal according to the invention.

### DETAILED DESCRIPTION OF THE INVENTION

The invention relates to a reverse logistics waste management system and method for collecting products and materials and recycling and/or disposing of those materials, including collection and separation of materials from one or more waste generators; transportation of the collected and separated materials to appropriate processing site(s); determination of treatment options for collected and separated materials; processing and/or disposal of the materials either as recyclables and/or waste; and reporting of the final processing and/or disposition of the materials to the waste generator.

Businesses today have rising concerns due to increased waste generation. For a business, waste generation lowers profits while enlarging operating costs. Many businesses have enacted waste management programs that include waste reduction efforts as well as recycling efforts.

A number of types of waste are generated by nearly all businesses such as paper, certain metals (such as aluminum cans) and plastic. Other types of waste are unique to the waste generating person, business or other entity. Certain types of waste require special disposal according to local, state and federal rules, regulations and laws. For example, chemical plants generate certain chemicals, automobile repair services discard used motor oil or used tires and medical laboratories generate human waste products, each of which requires specialized disposal that can be costly budget items.

Certain other types of waste do not require special disposal, yet disposal costs are increasing for a number of reasons. For example, landfills in the populous East Coast of the United States are closing, and it is becoming more difficult to open new landfills. Accordingly, the cost for disposing waste in landfills is increasing. The public's concern for conservation is another factor. Many companies like to advertise the efforts they make to conserve resources as part of their marketing.

One approach to waste management is to analyze a business's waste generation, including the types of generated waste, and determine the optimum method of disposal. A number of factors may be considered in determining the optimum method of disposal. Cost of disposal in a landfill is often significant, but it is not always the only or even primary or major consideration in the final waste management plan. For example, another factor might be the value in marketing the business's efforts to reduce waste and/or recycle instead of disposing in landfills.

The costs of waste management can be reduced by taking into consideration factors present in a certain area along with current costs of different disposal methods for disposal of different types of waste. Current costs could include the cost per pound of dumping waste in a landfill including the cost of transportation compared to the costs of waste reduction and recycling, both of which have associated costs. Recycling may include different types of recycling processes for different types of recyclables. Combustion with energy recovery or incineration with no energy recovery may also be considered in analyzing current costs. Such costs may be reduced over time by having the flexibility to alter the plan according to the particular make-up of the generated waste to be disposed of at a certain time. Further, financial treatments of the costs of waste generation may affect the final plan. For example, localities, states or federal government may provide tax breaks or rebates for waste reduction efforts.

The invention will be discussed further in the context of a particular business. This discussion is for illustrative purposes only and the principles and operation of the invention are not intended to be limited in any manner by this discussion. Rather, the invention can be applied by those of ordinary skill in the art to a wide variety of businesses and other entities and persons, as well as a wide variety of types of generated waste.

Consider a retail business that deals in multiple daily loads of products. Such a business most likely uses pallets to move heavy loads of materials to help reduce handling and storage costs, as well as provide quick material movement by way of hand operated pallet jacks or forklifts. Containerization for transport has spurred the use of pallets. A large business may have up to 1,000 or more pallets stored and waiting for disposal at a time, and it can easily cost more than $2.00 apiece to handle and dispose of pallets. Pallets are an example of a material that could require a thoughtful disposal plan for a particular business such as this one.

The problems of just pallet disposal are due not only to sheer numbers but also due to the various pallet sizes, design and materials of manufacture. While most pallets are made of wood, some are made of plastic, metal, and even paper. Each material has advantages and disadvantages relative to the others that might depend on the load or the application for which a particular pallet is designed. The pallet material may need to be certified for handling of certain types of loads, as well as to satisfy regulations in different cities, states and countries. One common requirement is for ISPM 15 compliance that the pallet material has been heat treated or chemically treated and is incapable of being a carrier of invasive species of insects and plant diseases. The environment may be a factor in design.

Further, pallets can be of different sizes or designs, such as stringer pallets and block pallets, which may or may not be designed to be stackable with each other. This can create space problems to retain used pallets until disposal. A common sized pallet requires about four and one half cubic feet of storage space. Disposal may comprise one or a combination of processes. Pallets made of cheap wood may be discarded as trash to be disposed of in a landfill or an incinerator. This option is getting more expensive, as some states have started prohibiting pallets from landfills or may impose extra charges for dumping pallets.

Sometimes pallets are burned as firewood. This requires disassembly of the pallets which may entail removal of nails or staples, then stacking and removal of the boards. Paper or plastic pallets may be recyclable. More complex pallets made of such materials as hardwood, plastic and metal may require a deposit and must be returned for refund of the deposit. Some pallets can be repaired.

As can be seen, pallet disposal in and of itself can be quite complex. Businesses as this one, though, have many other types of waste that must also be disposed. Commonly, plastic and paper are collected and separated. While paper and plastic often end up in landfills, the business may also recycle some or all of these types of waste which in some areas is cheaper than dumping in a landfill. Again, disposal of these types of waste can pose problems when handled on a large scale such as this business. For example, there are many types of plastic that are typically collected—ABS, acetal, nylon, PET, polycarbonate, polyethylene (for example, HDPE and LDPE) and polypropylene, to name just a few. The business typically is paid by the pound for plastics by recycling facilities. The amount paid by the recycling facilities may or may not cover the costs of collecting and sometimes separating the plastic waste. Metal may also be collected and separated.

The system and method of the invention assists persons, businesses and other entities in designing waste management plans to process and/or dispose generated waste according to parameters of interest to the waste generator. Such parameters may include revenue maximization; environmental benefit; or any other parameter of interest to the waste generator. Decisions on processing and/or disposition may depend on a combination of these or any other factors. For example, a waste generator may determine that for a given load of generated waste, it may be most beneficial to recycle plastic, but dispose of pallets and paper in landfills. This may be based in whole or in part on the cost of landfill dumping, the amount paid by a recycling processor for the plastic along with the value of time it would take to separate paper from other waste and also the value of using or obtaining storage space to store pallets. The waste generator may also assign value to its goodwill generated in the marketplace by advertising its plastic recycling operation. The system and method of the invention thus allow a waste generator the opportunity to achieve one or more goals, including goodwill and revenue optimization, through its waste management process.

The system and method can take into account dynamic parameters in the market place and aspects that are unique to the physical location of the waste generator, particularly where an organization has multiple locations of business where waste is generated. In certain locales, it may be advantageous to have one waste management plan, but that plan may not be the most advantageous for another location. Each location can determine its plan according to local or regional parameters.

Further, the information tracking features of the invention allow for full accounting of the generated waste and its disposal. In one embodiment of the invention, generated waste is collected in collection units that are uniquely marked or labeled with one or more labels. Marking or labeling could be done by bar coding or radio frequency tagging (“RF tagging”), as is known in the art. In one embodiment, bar code labels are used to track all generated waste through the system. Additionally, bar code labels can be used to identify grades of waste, such as pallets.

In addition, the system and method of the invention allow for increased economies of scale by combining waste from a plurality of waste generators, whether associated with a single company or multiple companies and other persons and entities.

Collection units for collecting waste can be owned by the waste generator, or they can be provided by an entity operating the system and method of the invention. For waste having particularized disposal requirements, for example certain chemicals, the collection unit(s) may need to comply with local, state and federal laws and regulations for collecting and storing such types of waste. Collection units can be stored by the waste generator once they are full, in one embodiment of the invention. The collection units can be maintained in a transportable means, or they can be maintained in a space selected by the waste generator and transferred into a transportable means for transporting to a location of the system and method operator, or else to a location designated by the system and method operator. Transportable means may include a trailer capable of being hauled by a truck, a tractor trailer or a train, or it may include any other towable unit such as a packing crate that is capable of being hauled by a truck, a tractor trailer or a train. In one embodiment, collected waste can be sorted at the site of the waste generator. In another embodiment, waste can be collected but not sorted at the site of the waste generator.

As noted, collection units can be marked or labeled using any identifying information of interest to the waste generator. For instance, the marking can indicate the source of the generated waste (e.g., the waste generator or particular department within the waste generator). The type of generated waste may also be included in the marking (e.g., plastic, paper, aluminum, etc.), if the waste generator sorts the generated waste. The source of the waste as coming from units within the organization of the waste generator can be included for reporting and budgeting purposes. Additionally, or alternatively, the collection units may include other markings such as color coding to indicate source and type of generated waste. Marking can also indicate the dates of collection or pick-up of the generated waste. The waste generator may also choose to include any other information in the marking/labeling that may be of importance and/or interest regarding the generated waste. Markings and/or labels may also be used to identify materials and grades of certain waste, such as pallets, that are not, or cannot be, collected in collection units. In one embodiment, pallets may be graded to indicate the type of pallet and the intended disposal of each pallet. For example, pallets may be graded according to whether the pallet can be reused; whether the pallet is to be torn down and the pieces reused; the size and construction of the pallet; and identification of pallets suitable to satisfy specific needs of customers.

In one embodiment, bar code labels can be printed at the site of the waste generator that include specific information regarding the generated waste. In another embodiment, bar code labels and colored markers can be printed off-site and delivered to the site of the waste generator. For example, bar code labels or colored markers indicating type of material or pallet can be printed off-site and delivered to the site of the waste generator.

Once the collection units are full, or on a periodic or as-needed basis, the entity that operates the system and method of the invention can be contacted to retrieve the collection units and transport them to one or more facilities for warehousing of the collected waste. This can be accomplished in a variety of ways. The waste generator may call or fax the system/method operator. In one embodiment, a switch may be configured to send a signal to the system/method operator that a pick-up is desired at the site of the waste generator. This switch may be wired to send a signal over existing land connections, such as the public telephone system or the Internet. The system may also be a wireless system that is capable of transmitting such a signal, including but not limited to RF, satellite and microwave communications. The system may be configured to receive and send both wired and wireless communications.

When the system/method operator receives the pick-up signal, a confirmation communication may be sent to the waste generator. The confirmation may indicate merely confirmation of receipt of the pick-up signal, or it may include additional information such as the estimated time of pick-up. At pick-up, the collection units are loaded into a transportable unit, if not already in such a unit, and then removed from the location of the waste generator either by or at the request of the operator. In the case of system operator-provided transportable means, the system operator may provide one or more replacement collection units to replace the unit(s) that are being picked up.

The transportable means, as well as the collection units, can be equipped with tracking devices so that all such units can be accounted for within the closed waste management system. The tracking device also provides the location of any particular collection unit or transportable device upon inquiry.

Accounting for the collection units and their contents at the waste generator site can take place at pick-up by reading the markers or labels on the collection units. Also, the weight of the collection units can be recorded, if desired, at that time and the weight can either added to the existing marker or label, or otherwise placed on a separate marker or label and placed on the collection unit. Alternatively, the weight may be recorded manually or electronically using a handheld reading device for bar codes, RF tags, or other technology capable of performing a similar function. Alternatively, the information can be manually entered into a device having a memory, such as a laptop computer, a PDA, a Blackberry® or other device into which data can be entered and stored for later retrieval, in which case the stored information can be associated with identifying information of the collection unit for later retrieval. At the time of pick-up, the waste generator may account for individual items within the generated waste. For example, pallets may contain individual serial numbers or other identification, which may be recorded and provided to the system operator at the time of pick-up. The waste generator may also provide the system operator with a verification of the contents of the pick-up.

The transportable units can then be taken to one or more warehousing, or consolidation, centers where the collection units are unloaded and information regarding the collection units are recorded. Recordation may include weight; types of generated waste; waste generator identification; date and time of pick-up and delivery to the processing center(s); and any other information that the waste generator or the system operator may want to note. This may be done manually or it may be done by reading the marker(s) and label(s) on the collection units. In one embodiment, the contents of the collection units can be unloaded and sorted at the warehousing center, and markers and labels can be created that record information about the waste.

In one embodiment, information regarding the collected waste can be recorded at the warehousing center and entered into labels that are attached to the generated waste, such as the collection unit or the pallet. The markers or bar code labels can be printed at the site of the warehousing center. In another embodiment, the bar code labels can be printed and delivered to the site of the warehousing center. For example, bar code labels or colored markers indicating type of material or pallet can be printed off-site and delivered to the site of the warehousing center.

The emptied transportable units may then be cleaned for future use.

Filled collection units may be stored at the warehousing center in a staging area until sent to an appropriate processor for the generated waste. Accordingly, similar types of waste from multiple waste generators, and/or multiple pick-ups from a waste generator, may be accumulated in the staging area. For example, the system operator may wait until a certain amount of a particular type of generated waste (e.g., glass or plastic) has been collected so that a better price can be realized from a processor of that type of waste due to aggregated volumes or weight. This can improve proceeds from the sale of waste for recycling for all waste generators participating in the system of the invention.

The operator of the system may send the individual collection units substantially as received from the waste generators on to the processing facilities, or otherwise the system operator may combine the waste from a plurality of collection units before sending the waste on to the processing facility. In the first instance, the system operator may record the date, time and processing facility that the collection unit arrives and leaves the warehousing center. In the second instance, the operator of the system may record information regarding all collection units that are amassed in a larger grouping, and then record the date, time and processing facility that the larger grouping is sent to further processing facilities. This information can be added to stored information (described below) regarding each collection unit.

Information regarding each collection unit of generated waste can be collected wherever desired throughout the system and stored in one or more databases. Information can be collected by reading labels, such as bar code labels, or other markers, such as RFID tags, and recording the information at different locations within the system. For example, a collection unit may receive a bar code at the site of the waste generator that includes the type of material, the weight of the generated waste in the collection unit as picked up by the system operator, the date of pick-up and an identifier of the waste generator. When the collection unit arrives at the warehousing center, the information on the label can be read and recorded in the database(s), along with additional information gathered at the warehousing center. For example, the type and weight of generated waste may be re-read at the point of arrival at the warehousing center, and that information may be input into the database(s) along with the information on the label applied at the site of the waste generator. As the collection unit is transported to further processing, data may be read at various points that record the location within the system of any specific collection unit at any time.

In one embodiment, the database(s) are located on one or more systems of or operated on behalf of the system operator. Such systems are known to those skilled in the art and can be adapted without undue experimentation for use in the system and method of the invention. The stored information can be available to the waste generator by mail, by fax, by phone or by Internet. The waste generator may be provided controlled access to the database, or to a limited part of the database, by way of a password, PIN, biometric or other method of remote identification and verification. The database can be included in a programmed computer system that is programmed to report data to the waste generator in a variety of formats. For example, the waste generator may be able to track the amount of waste generated by facility, by department and by type of generated waste over time. Total costs of disposing the generated waste can likewise be tracked and reported. Such information can be analyzed by the system operator and/or the waste generator to develop or improve waste management plans.

The disposal method may be determined according to information stored in the programmed computer system for the waste present at the warehousing center at any time. Information can be stored in the programmable computer system regarding the processing of various types of waste, which information may be specific to the particular type of waste involved, and may include (if applicable) information about costs of landfill dumping or payments made by recycling processors for that particular type of waste. This information can be updated as often as desired. Additionally, information about the costs of collecting and transporting waste from the waste generator center to the ultimate processor, including storage costs, manpower costs to segregate and load waste into appropriate collection units, transportation costs of transporting waste to a warehousing center and/or to a processor, can be stored. This calculation can also take into account any benefits for particular types of processing choices. Using this information or any other information, such as local, state or federal taxes, surcharges or rebates, an optimum method of disposal, as well as a range of costs of disposal, can be calculated for a particular load of collected waste.

The system and method can assist the waste generator in tracking and reporting compliance with local, state and federal regulations and statutes regarding waste management, including disposal. For example, the programmable computer system may be programmed to provide reports in formats designated or preferred by the waste generator, or designated by local, state or federal authorities for specific types of generated waste. Further, the system operator may report disposal information directly to such authorities on behalf of the waste generator.

The collection units and the transportable units additionally provide marketing opportunities for the system operator. The system operator's brand can be displayed on these units, along with contact information and descriptive information about the system.

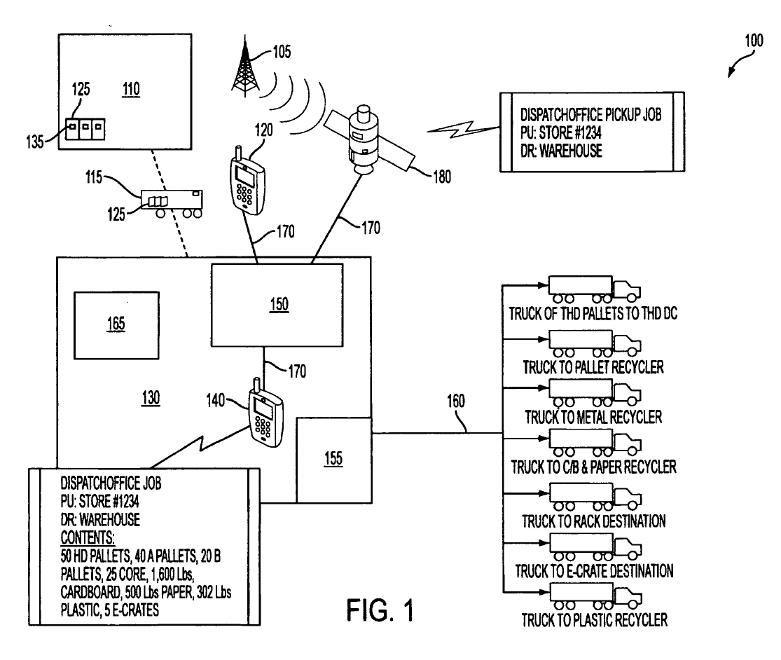

Turning to the figures, FIG. 1 depicts one embodiment of the invention regarding a closed loop waste management system 100 comprising a transmitter 105 to transmit a communication from the waste generator 110 that collected waste is ready to be picked up by the system operator; transportable unit 115 to transport collection units 125 that contain the collected waste of the waste generator 110; a first interface unit 120 configured to record information about generated waste that is picked up from the waste generator 110 and verification of pick-up; a warehousing center 130 where collected waste is brought by transportable unit 115; a second interface unit 140 configured to record information at the warehousing center 130 about collection units 125 and other generated waste unloaded from the transportable unit 115; and a programmable computer system 150 for communicating with first and second interface units 120 and 140, for storing information regarding collected waste received at the warehousing center 130 and disposition of the generated waste to processors 160 and for providing access to information about the collected waste, including its disposition, to waste generator 110. The programmable computer system 150 communicates with first and second interface units 120 and 140 along communication lines 170. Communication to and from system 100, including programmable computer system 150, and waste generator 110 can be performed over existing communication systems, such as satellite 180, the Internet or any other wired or wireless communication system now known or later developed.

Collection units 125 may include markers or labels 135 that include information about the collected waste. Such information may include the type of waste; the identity of waste generator 110; the location of the collection of waste; the date that the collected waste is picked up from waste generator 110; and any other information that may be desirable to be known and recorded by waste generator 110 and/or the system operator. The markers or labels 135 may be in the form of, for example, bar code labels or RF tags. The markers or labels 135 may be placed on the collection units 125 or pallets collected at the site of the waste generator 110. Alternatively, or additionally, markers or labels 135 may be placed on collection units 125 or pallets at the warehousing center 130. For example, a marker or label 135 may be placed on a collection unit 125 at the site of the waste generator 110 that includes information such as the identity of the waste generator 110 and the date of pick up of the collected waste. Additional markers or labels 135 may be placed on the collection unit 125 at the warehousing center 130 that detail the type of waste, or the method of disposal for that collection unit 125. As many markers or labels 135 as desired may be affixed to collection units 125.

In one embodiment, collected waste may be collected without regard to sorting at the site of the waste generator 110, and then sorted and/or aggregated at the warehousing center 130. In one embodiment, collection units 125 may be emptied at warehousing center 110 and like waste may be aggregated and stored. In this embodiment, markers or labels 135 may be placed on containers containing the aggregated collected waste.

The information stored in programmable computer system 150 can be stored and utilized in a variety of ways. It allows the generated waste to be tracked through the system 100 according to information read from markers and labels 125, which information can be transmitted to the programmable computer system 150 and stored in memory units that are accessible by the system operator, the waste generator 110 or anyone else that is granted access. For example, the stored information can be utilized to determine the best disposal method for the generated waste that is present at the warehousing center 130 at any one time. This determination may be made based on prices offered to purchase certain types of collected waste along with other disposal costs at that point in time. Disposal costs could include, for example, landfill costs, transportation costs and local government surcharges. The type of disposal method for the generated waste can be indicated in a marker or label 135 that is placed on a collection unit 125 or on a container in which generated waste is sorted and/or aggregated at the warehousing center 130.

Collection units 125 or containers in which generated waste is sorted and/or aggregated at the warehousing center 130 may be stored at the warehousing center 130 in a staging area 155. In one embodiment, collection units 125 are stored in the staging area 155 according to a common feature of the generated waste contained in the collection units 125. For example, collection units 125 may be stored according to type of waste contained in the collection units 125, or they may be stored according to type of disposal planned for the collection units 125. The decision of how to store the collection units 125 may be dynamic, depending on the particular inventory of collected waste and the type of disposal method. In one embodiment, collection units 125 can be stored according to type of generated waste, and the disposal method may be determined when the amount of generated waste in staging area 155 reaches a predetermined level at which point the aggregated collection units 125 are dispatched out of the warehousing center 130 to a waste processor or recycled to a customer.

Certain types of generated waste may undergo further processing at the warehousing center 130. Pallets, for example, may be taken to a repair center 165 located at warehousing center 130 where they are marked or labeled 125 according to type of pallet and origination information. Repairable pallets can be repaired, and pallets can be graded and stacked with like pallets. Pallets that are determined not to be repaired, whether based on condition of the pallet or any other reason, can be broken down and pieces may be used to repair other pallets. Pallets may be stacked in staging area 155 where they may then be dispatched for sale or distribution.

Container units 125, containers in which generated waste is sorted and/or aggregated at the warehousing center 130 and/or recycled waste, such as pallets, can be transported 160 from the warehousing center 130 to processors for that waste or to customers as recycled and/or repaired items. Information about which container units 125, other containers or recycled waste items can be recorded prior to being loaded for further transport 160, which information can be communicated to and stored in the programmable computer system 150 for inventory reconciliation and reporting to the waste generator 110. Confirmation of ultimate disposal by processors can also be transmitted back to the programmable computer system 150 and provided to the waste generator 110.

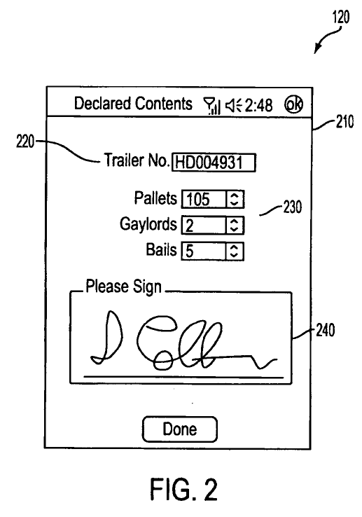

FIG. 2 depicts one embodiment of a first interface unit 120 for recording information about a transportable unit 115, including information regarding collection units 125 picked up at a waste generator facility by the transportable unit 115, along with verification by a representative of the waste generator 110 of the recorded information. Information can be entered into first interface unit 120 through touch screen 210, which can include a plurality of data entry displays for entering data such as identifier 220 of transportable unit 115; a description of collected waste 230; and a verification entry 240 which could comprise, for example, a signature of a representative of waste generator 110. This information can be transmitted to or otherwise downloaded into programmable computer system 130 and saved for later analysis and review by the system operator and the waste generator 110. Information may be entered into first interface unit 120 manually, or it may be entered in whole or in part by reading the marker or label 135 on the collection unit 125 if first interface unit 120 is equipped with a marker or label reader (not shown).

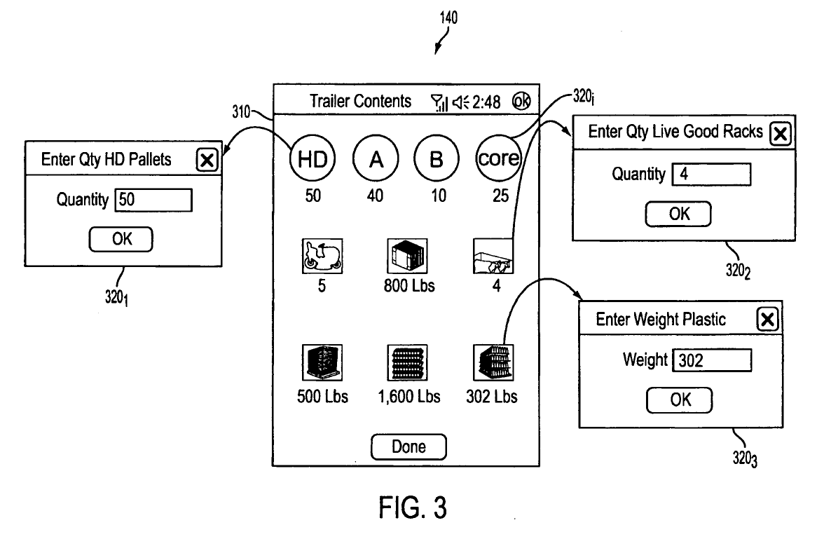

FIG. 3 depicts one embodiment of a second interface unit 140 for recording information about collection units 125 delivered via transportable unit 115 to warehousing center 130. Second interface unit 150 may contain a touch screen 310 comprising a plurality of displays 320ᵢ that correspond to various types of collected waste. For example, information on the number of pallets in the collected waste in transportable unit 115 may be entered into second interface unit 140 by touching display 320₁ and entering the appropriate information; information on the number of live good racks may be by touching display 320₂ and entering the appropriate information; and information on the weight of collected plastic weight may be entered by touching display 320₃ and entering the appropriate information. Alternatively, or in addition, information about the collected waste may be read from the marker or label 135 on each collection unit 125. The organization of the screen of second interface unit 140 can be arranged as appropriate for use in any particular system. This information can later be transmitted to or otherwise downloaded into programmable computer system 130 and saved for later analysis and review by the system operator and the waste generator 110.

Additional interface units (not shown) may be used that enable the system operator to read markers and labels 135 at any point in the system 100 to determine the location of collected waste at any point in time. Such interface units may be similar to the first or second interface units, or may comprise any interface unit now known or later developed that are configured to read the markers and labels 135 used in the system 100.

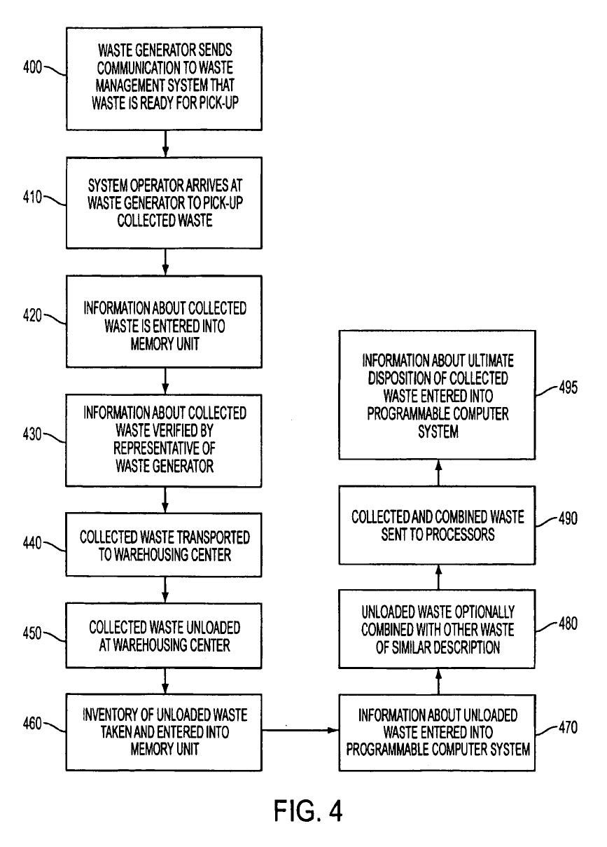

FIG. 4 depicts one embodiment of the invention relating to a closed loop waste management method. At step 400, the operator of the waste management system receives a communication from a waste generator that collected waste is ready to be picked up. System operator arrives at waste generator to pick up the collected waste using a transportable unit at step 410. Information about the collected waste to be picked up is entered into a memory unit at step 420, which information is verified by a representative of the waste generator at step 430. The collected waste is transported to a warehousing center at step 440 where it is unloaded at step 450. An inventory of the unloaded waste is taken at the warehousing center at step 460. The system operator may compare the inventory taken at the site of the waste generator to the inventory taken when unloading the waste. Information about the collected waste is entered into a programmable computer system for storage at step 470 where it can be accessed for review and analysis by system operator and the waste generator. The unloaded waste is combined with other waste of similar description at step 480 at the warehousing center. Collected waste is sent out for processing to various processors at step 490, and information about the ultimate disposition of the collected waste is stored in the programmable computer system at step 495 where it can be accessed and reviewed by system operator and the waste generator.

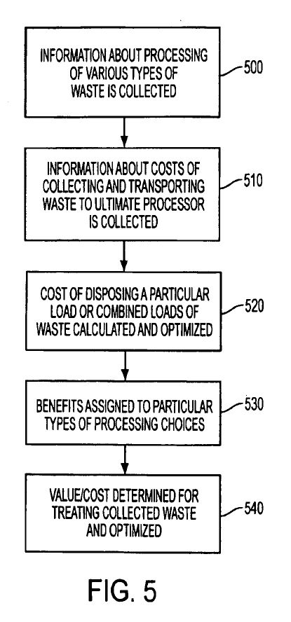

FIG. 5 depicts one embodiment of the invention relating to a method for designing a waste management plan to achieve one or more goal(s) with regard to waste disposal. At step 500, information about processing of various types of waste is collected. This information may be specific to the particular type of waste involved, or may include (if applicable) information about costs of landfill dumping or payments made by recycling processors for that particular type of waste. Information about the costs of collecting and transporting waste to the ultimate processor from the waste generator, including storage costs, manpower costs to segregate and load waste into appropriate collection units, transportation costs of transporting waste to a warehousing center and/or to a processor, can be collected at step 510. At step 520, the cost of disposing a particular load or combined loads of waste can be calculated and optimized. Such calculations can be performed by a programmable computer having a standard central processing unit configured to carry out such calculations. At step 530, benefits can be assigned to particular types of processing choices. At step 540, a value/cost is determined for treating the collected waste, which may be optimized.

For example, the costs of handling various types of waste for a certain location X of Company A may be entered into the method of the invention. Such costs may include costs of manpower to collect and segregate waste; transportation and storage costs; payments made by recyclers for various types of waste; and costs of disposal of special types of waste. Further, Company A may be entering into a marketing campaign that emphasizes its environmentally conscious business methods. Company A may determine that its least cost for disposing of a certain group of waste from location X comprises returning certain pallets for a refund; repairing and reselling pallets determined to be repairable; dumping pallets not repairable into a landfill; recycling all paper products; and recycling certain types of plastic waste and dumping other types of plastic weight into a landfill. However, even though it may cost less to dispose of certain types of waste in a landfill, Company A may assign a greater value to marketing that may result in recycling of all of the plastic rather than dumping some of it in a landfill.

Further, the tracking of the collected waste through the system of the invention allows for detailed reporting to the waste generator at whatever level of detail is desired. This information can be associated with the collected waste by way of the markers or labels on the collection units, for example, if the waste generator wants to know the make-up of the collected waste within a particular location or the location of a particular collection unit or pallet. The waste generator may choose to maintain costs at the level of the entire location instead. This information can be stored in the programmable computer system of the operator of the system where it can be retrieved and analyzed by the waste generator. The waste generator may use this information to alter its business habits, such as by changing its buying habits to alter the make-up of its waste stream. The waste generator may charge or credit the cost or benefit of waste disposal to various business units at each location which may affect profitability of individual business units and be considered in business plans. Further, the detailed information on waste disposal may be formatted to create reports for compliance purposes according to local, state and federal regulations for certain types of waste.

The embodiments herein disclose the closed waste management system and method in conjunction with a particular type of waste generating business. However, other entities, including persons and businesses, could similarly use the system and method of closed waste management. The foregoing embodiments have been presented for the purpose of illustration and description only and are not to be construed as limiting the scope of the invention in any way. The scope of the invention is to be determined from the claims appended hereto.

What is claimed is:

1. A waste management system comprising:
a receiver configured to receive a transmission from a waste generator that collected waste is ready to be picked up;
a transportable unit configured to transport one or more container units of collected waste along with optionally other units of collected waste, wherein the container units and other units of collected waste each comprise at least one unique identifier, wherein further the transportable unit comprises a trackable identifier;
collected waste information comprising the unique identifier of each container unit or other unit of collected waste and a description of the collected waste as collected at the site of the waste generator;
a first interface unit configured to receive, store and transmit the collected waste information, wherein the first interface unit is further configured to receive, store and transmit verification by a representative of the waste generator of the collected waste information;
a warehousing center comprising facilities to store and optionally combine contents of container units or other units of collected waste;
warehousing information comprising the unique identifier of the container units or other units of collected waste and a description of the collected waste, obtained substantially upon initial arrival of the collected waste at the warehousing center;
a second interface unit configured to receive, store and transmit the warehousing information;
disposal cost information comprising identification of processors to dispose various types of waste and their respective costs of disposal;
ultimate disposal information comprising the unique identifier of specific container units or other units of collected waste, date of ultimate disposal of those specific container units or other units of collected waste, method of ultimate disposal, identification of processor and cost of ultimate disposal;
a programmable computer system comprising a receiving unit configured to receive collected waste information, warehousing information, disposal cost information, ultimate disposal information or combinations thereof, the programmable computer system further comprising a memory unit for storing the collected waste information, the warehousing information, the disposal cost information and the ultimate disposal information in a searchable database; and
a computer system interface configured to allow access to at least the stored collected waste information, warehousing information, disposal cost information and ultimate disposal information by the waste generator,
wherein the programmable computer system further comprises an optimization unit configured to utilize the disposal cost information to determine the costs of disposing the collected waste according to the collected waste information and the warehousing information.

2. A waste management method, comprising;
receiving a transmission from a waste generator that collected waste is ready to be picked up;
loading one or more container units of collected waste along with optionally other units of collected waste onto a transportable unit, wherein each container unit and each other unit of collected waste comprises at least one unique identifier, wherein the transportable unit comprises a trackable identifier;
entering into a first interface unit collected waste information collected at the site of the waste generator, the collected waste information comprising the unique identifier of the container unit or other unit of collected waste and a description of the collected waste;
storing in the first interface unit verification of the collected waste information by a representative of the waste generator of the collected waste information;
transporting the collected waste to a warehousing center, the warehousing center comprising facilities to store and optionally combine contents of container units or other units of collected waste;
entering into a second interface unit warehousing information regarding the collected waste obtained substantially upon arrival of the collected waste at the warehousing center, the warehousing information comprising the unique identifier of the container units or other units of collected waste and a description of the collected waste;
receiving by a receiving unit of a programmable computer system collected waste information, warehousing information or combinations thereof;
storing in a memory unit of the programmable computer system collected waste information, warehousing information and disposal cost information, wherein the disposal cost information comprises the identification of processors to dispose various types of waste and their respective costs of disposal, wherein the memory unit comprises a searchable database;
determining by an optimization unit of the programmable computer system the disposal cost of selected collected waste according to the disposal cost information and the collected waste information and the warehousing information for the selected collected waste;
disposing of the selected waste according to the optimum disposal as determined by the optimization unit;
receiving by the memory unit ultimate disposal information regarding the ultimate disposal of the collected waste, the ultimate disposal information comprising the unique identifier of the container unit or other unit of collected waste, date of ultimate disposal, method of ultimate disposal, identification of processor and cost of ultimate disposal; and
allowing access by the waste generator to areas of the memory unit relating to disposal of collected waste via a computer system interface.

3. A method of designing a waste disposal plan, comprising:
collecting disposal information regarding processing of various types of waste, the disposal information comprising cost of disposal of waste by various methods and identification of various waste processors;
collecting information regarding benefits to a waste generator for disposing of waste by a certain method or processor;
determining the cost of disposing a particular collection of waste for each combination of method and processor appropriate for that type of waste;
determining the cost of storing and transporting the particular collection of waste for each combination of each method and processor;
determining the benefit to the waste generator for disposing the particular collection of waste for each combination of method and processor;
ascertaining a value for disposing the particular collection of waste for each combination of method and processor according to the cost of disposing the collected waste, the cost of transportation and storage for the collected waste and the benefit to the waste generator; and
determining which combination of method of disposal and processor is most advantageous to the waste generator for the particular collection of waste.
